(19) United States
(12) Patent Application Publication
(10) Pub. No.: US 2019/0195713 A1
(43) Pub. Date: Jun. 27, 2019

(54) OPERATION PROCESSING APPARATUS, TORQUE SENSOR AND POWER STEERING APPARATUS

(71) Applicant: TDK Corporation, Tokyo (JP)

(72) Inventors: Shinichirou MOCHIZUKI, Tokyo (JP); Hiraku HIRABAYASHI, Tokyo (JP)

(21) Appl. No.: 16/163,844

(22) Filed: Oct. 18, 2018

(30) Foreign Application Priority Data
Dec. 26, 2017 (JP) 2017-249501

(51) Int. Cl. G01L 5/22; B62D 6/10; G01L 3/10; B62D 5/04

(52) U.S. Cl. CPC G01L 5/221; B62D 6/10; B62D 5/0481; B62D 5/046; G01L 3/104

(57) ABSTRACT

An operation processing apparatus computes torque generated in a first rotation shaft and a second rotation shaft connected to each other and arranged coaxially using first and second output signals (a first sine wave signal S_{S1}, a first cosine wave signal S_{C1}, a second sine wave signal S_{S2}, and a second cosine wave signal S_{C2}) output from first and second magnetic sensor elements in accordance with rotation of the first and second rotation shafts is provided with a phase difference calculation part that computes a relative phase difference C_{PD} between the first and second rotation shafts from the first and second output signals based on the Equation (1) and a torque calculation part that computes the torque from a relative twist angle of the first and second rotation shafts found on the basis of a correlation between the relative phase differences.

C_{PD}=\sqrt{(S_{S1}−S_{S2})²+(S_{C1}−S_{C2})²} (1)

### CROSS REFERENCE TO RELATED APPLICATIONS

The present application is based on Japanese Patent Application No. 2017-249501 filed on Dec. 26, 2017, the disclosure of which is incorporated herein by reference.

### FIELD OF THE INVENTION

The present invention relates to an operation processing apparatus that calculates a torque value based on an output signal from a sensor element, a torque sensor and a power steering apparatus.

### BACKGROUND OF THE INVENTION

In a power steering apparatus or the like for a vehicle, multipolar magnets are provided at both ends of a torsion bar, magnetic flux in accordance with the positional displacement of these multipolar magnets is detected by a magnetic sensor, a twist angle (relative twist angle) generated in the torsion bar is calculated from the detected magnetic flux, and a torque sensor is used to detect the torque value from this twist angle. The driver can steer with a small steering force by driving a motor or hydraulic apparatus based on the torque value detected by this torque sensor to assist the steering force of the steering wheel.

### PRIOR ART

### Patent Literature

### [PATENT LITERATURE 1] JP Laid-Open Patent Application No. 2017-44683

### SUMMARY OF THE INVENTION

### Problem to be Solved by the Invention

In the torque sensor disclosed in Patent Literature 1, a first rotational angle sensor is provided in correspondence with a first multipolar ring magnet that is attached to an input shaft and that can rotate synchronously with the input shaft, and a second rotational angle sensor is provided in correspondence with a second multipolar ring magnet that is attached to an output shaft and that can rotate synchronously with the output shaft. Furthermore, the rotational angle of the input shaft is computed based on a sensor signal output from the first rotational angle sensor, the rotational angle of the output shaft is computed based on a signal output from the second rotational angle sensor, and a relative angle (twist angle between the input shaft and the output shaft) Δθ is computed by calculating the difference between these. Furthermore, the steering torque is calculated based on the relative angle Δθ.

The sensor signals output from the first rotational angle sensor and the second rotational angle sensor each include a sine wave signal (sin signal) and a cosine wave signal (cos signal) indicating the respective rotational angles of the input shaft (first multipolar ring magnet) and the output shaft (second multipolar ring magnet), and each of the rotational angles is computed from an arctangent operation (atan operation) using the sine wave signal and the cosine wave signal. That is to say, in addition to finding the rotational angle of the input shaft by calculating the arctangent (atan) from the sensor signals (sin signal and cos signal) output from the first rotational angle sensor, it is necessary to find the rotational angle of the output shaft by also similarly calculating the arctangent (atan) from the sensor signals (sin signal and cos signal) output from the second rotational angle sensor. Consequently, the problems exist that the circuit size of the operation processing circuit necessary for arctangent operation processing becomes large, and the power consumption in the angle detection apparatus including the operation processing circuit becomes large. In addition, a large number of clock cycles is taken in calculating the arctangent (atan), so the operation processing time in the operation processing circuit becomes long.

In consideration of the foregoing, it is an object of the present invention to provide an operation processing apparatus, which can calculate the relative angle (twist angle) of two coaxial rotational shafts in a short time and can reduce the power consumption in the operation processing circuit that accomplishes this calculation process, a torque sensor equipped with this operation processing apparatus, and a power steering apparatus equipped with this torque sensor.

### Means for Solving the Problem

In order to resolve the above problems, the present invention provides an operation processing apparatus that computes torque generated in a first rotation shaft and a second rotation shaft connected via a torsion bar and arranged coaxially by using a first output signal including a first sine wave signal and a first cosine wave signal output from a first magnetic sensor element in accordance with rotation of the first rotation shaft, and a second output signal including a second sine wave signal and a second cosine wave signal output from a second magnetic sensor element in accordance with rotation of the second rotation shaft. The operation processing apparatus includes a phase difference calculation part that computes the relative phase difference between the first rotation shaft and the second rotation shaft from the first output signal and the second output signal based on the Equation (1) below, and a torque calculation part that computes the torque from a relative twist angle that is expressed as a difference in rotational angles between the first rotation shaft and the second rotation shaft and that is found based on a correlation between the relative phase differences computed by the phase difference calculation part.

[Formula 1]

C_{PD}=\sqrt{(S_{S1}−S_{S2})²+(S_{C1}−S_{C2})²} (1)

In Equation (1), C_{PD} indicates the relative phase difference, S_{S1} indicates the first sine wave signal, S_{C1} indicates the first cosine wave signal, S_{S2} indicates the second sine wave signal and S_{C2} indicates the second cosine wave signal.

In this specification, a “sine wave signal” also includes signals (approximate sine wave signals) expressed by waveforms extremely close to waveforms of ideal sine waves (distortion ratio within 30%), besides signals expressed by waveforms of ideal sine waves. In addition, in this specification, a “cosine wave signal” also includes signals (approximate cosine wave signals) expressed by waveforms extremely close to waveforms of ideal cosine waves (distortion ratio within 30%), besides signals expressed by waveforms of ideal cosine waves. The distortion ratio is measured by separating the ideal component and the distorted component of the signal using a method such as Fourier analysis or the like and using an evaluable distortion ratio measurement apparatus. In addition, the sine wave signal and the cosine wave signal are intended to allow the phase difference thereof to deviate within 90 deg±20 deg.

The above-described operation processing apparatus further includes a memory part that stores the correlation between the relative twist angles and the relative phase differences in advance. The torque calculation part can compute the torque from the relative twist angle found based on the correlation stored in the memory part and the relative phase difference computed by the phase difference calculation part, and the relative twist angle may be preferably 10° or less.

The present invention provides a torque sensor that includes the above-described operation processing apparatus, a first magnetic field generation part that is provided on the first rotation shaft and rotates integrally with the first rotation shaft, a second magnetic field generation part that is provided on the second rotation shaft and rotates integrally with the second rotation shaft, and a magnetic sensor part that includes the first magnetic sensor element and the second magnetic sensor element. The first magnetic field generation part and the second magnetic field generation part tare multipolar magnets such that the different magnetic poles are arranged alternately in a radial direction, the first magnetic sensor element outputs the first output signal in accordance with the magnetic field generated from the first magnetic field generation part, and the second magnetic sensor element outputs the second output signal in accordance with the magnetic field generated from the second magnetic field generation part.

In the above-described torque sensor, each of the first magnetic sensor element and the second magnetic sensor element may be a TMR element, a GMR element, an AMR element or a Hall element.

The present invention provides a power steering apparatus that includes a power generation part that gives power to a steering mechanism for steering and assists the steering power of the steering, the above-described torque sensor, and a control part that drives the power generation part in accordance with the torque detected by the torque sensor.

### Effects of the Invention

With the present invention, it is possible to provide an operation processing apparatus that can calculate the relative angle (twist angle) of two rotational shafts arranged coaxially in a short time and that can reduce the power consumption in the operation processing circuit that accomplishes the operation processing, a torque sensor equipped with the operation processing apparatus and a power steering apparatus equipped with the torque sensor.

### BRIEF DESCRIPTION OF THE DRAWINGS

FIG. 1 is a perspective view showing the schematic configuration of a torque sensor according to the embodiment of the present invention.

FIG. 2 is a block diagram showing the schematic configuration of a magnetic detection apparatus in the embodiment of the present invention.

FIG. 3 is a circuit diagram schematically showing the circuit configuration of a 1^{st}-1 Wheatstone bridge circuit in the embodiment of the present invention.

FIG. 4 a circuit diagram schematically showing the circuit configuration of a 1^{st}-2 Wheatstone bridge circuit in the embodiment of the present invention.

FIG. 5 a circuit diagram schematically showing the circuit configuration of a 2^{nd}-1 Wheatstone bridge circuit in the embodiment of the present invention.

FIG. 6 a circuit diagram schematically showing the circuit configuration of a 2^{nd}-2 Wheatstone bridge circuit in the embodiment of the present invention.

FIG. 7 is a perspective view showing the schematic configuration of an MR element as a magnetic sensor element in the embodiment of the present invention.

FIG. 8 is a cross-sectional view showing the schematic configuration of the MR element as a magnetic sensor element in the embodiment of the present invention.

FIG. 9 is a schematic diagram showing the configuration of an electric power-assisted steering apparatus provided with the torque sensor according to the embodiment of the present invention.

### MODE FOR CARRYING OUT THE INVENTION

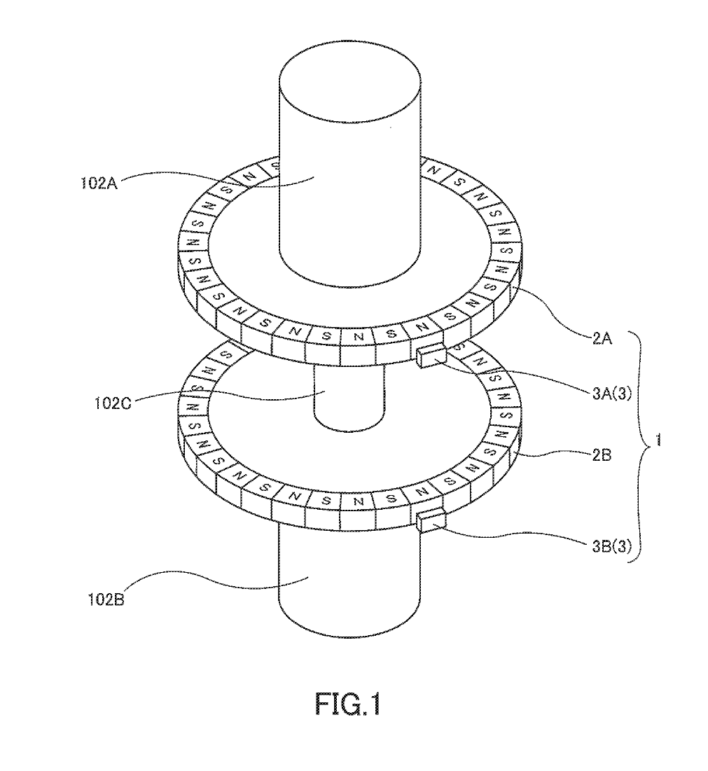

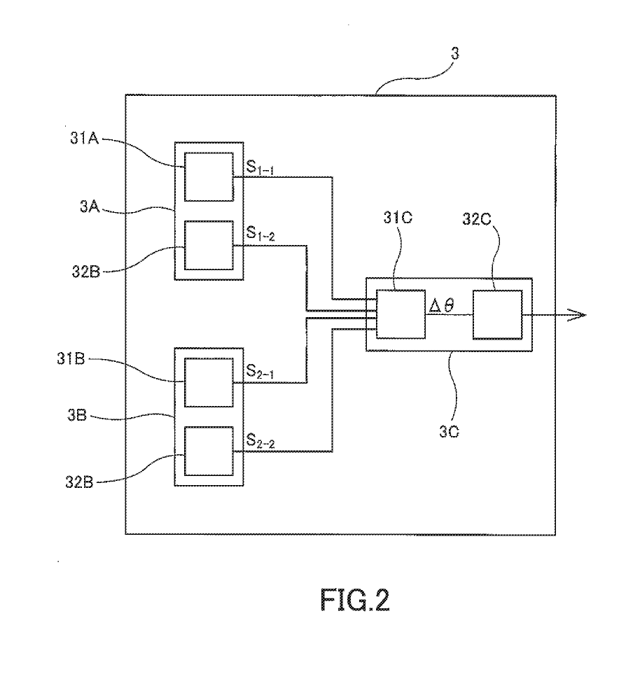

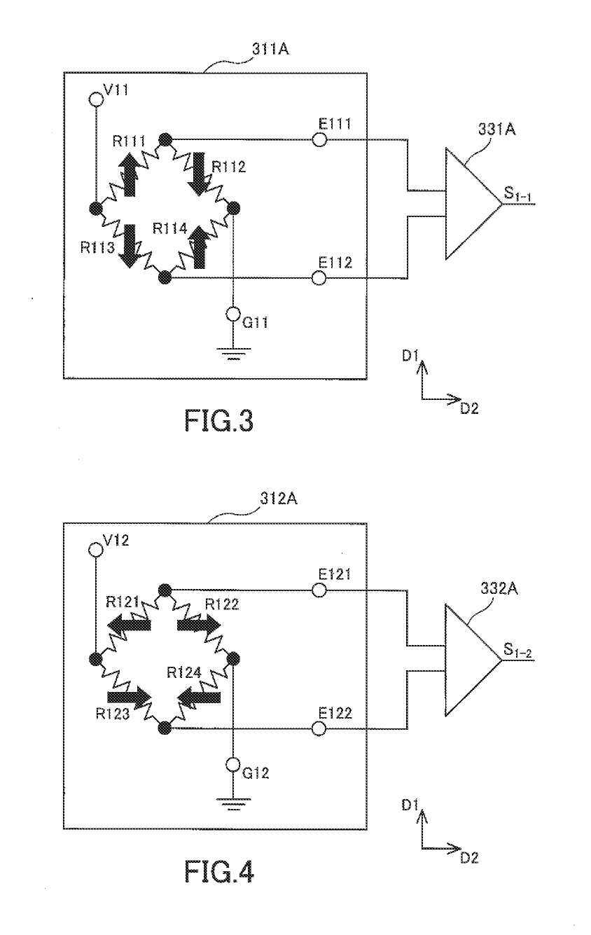

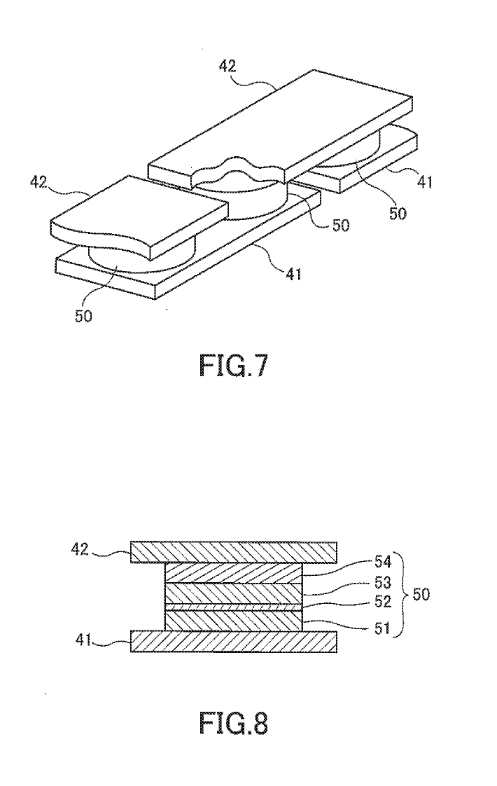

The embodiment of the present invention will be described in detail with reference to the drawings FIG. 1 is a perspective view showing the schematic configuration of a torque sensor according to this embodiment; FIG. 2 is a block diagram showing the schematic configuration of a magnetic detection apparatus in this embodiment; FIGS. 3˜6 are circuit diagrams schematically showing the circuit configuration of a 1^{st}-1 Wheatstone bridge circuit, a 1^{st}-2 Wheatstone bridge circuit, a 2^{nd}-1 Wheatstone bridge circuit and a 2^{nd}-2 Wheatstone bridge circuit in this embodiment of the present invention; and FIG. 7 and FIG. 8 are a perspective view and a cross-sectional view showing the schematic configuration of an MR element as a magnetic sensor element in this embodiment. In this embodiment, a torque sensor used in an electric power-assisted steering apparatus for a vehicle will be described as an example.

A torque sensor 1 according to this embodiment is provided with a first multipolar magnet 2A that is provided on one end of an input shaft 102A (one end on an output shaft 102B side) connected to a steering wheel 101, a second multipolar magnet 2B provided on one end of the output shaft 102B (one end on the input shaft 102A side) connected to the input shaft 102A via a torsion bar 102C, and a magnetic detection apparatus 3 that includes a first magnetic detection apparatus 3A arranged to face the first multipolar magnet 2A and a second magnetic detection apparatus 3B arranged facing the second multipolar magnet 2B.

The first multipolar magnet 2A and the second multipolar magnet 2B are rotatably provided on one end of the input shaft 102A and one end of the output shaft 102B about a rotational axis RA. The multipolar magnets 2A, 2B rotate about the rotational axis RA while interlocked with the rotation of the input shaft 102A and the output shaft 102B.

The first multipolar magnet 2A and the second multipolar magnet 2B have a plurality of pairs of N poles and S poles, and the N poles and S poles are arranged radially (in a ring shape) alternately with each other. The first multipolar magnet 2A and the second multipolar magnet 2B generate magnetic fields based the magnetization each possesses. In this embodiment, the number of poles of the first multipolar magnet 2A and the second multipolar magnet 2B is 15, but the number of poles of the first multipolar magnet 2A and the second multipolar magnet 2B is not limited to this.

The first magnetic detection apparatus 3A is arranged to face the first multipolar magnet 2A, and detects the magnetic field produced by the first multipolar magnet 2A. The second magnetic detection apparatus 3B is arranged to face the second multipolar magnet 2B, and detects the magnetic field produced by the second multipolar magnet 2B. As described below, the torque sensor 1 according to this embodiment can find the torque based on the respective outputs of the first magnetic detection apparatus 3A and the second magnetic detection apparatus 3B.

The magnetic detection apparatus 3 has the first magnetic detection apparatus 3A, the second magnetic detection apparatus 3B and an operation processor 3C. The first magnetic detection apparatus 3A includes a first magnetic sensor 31A that outputs a sensor signal based on changes in the magnetic field accompanying rotation of the first multipolar magnet 2A. The second magnetic detection apparatus 3B includes a second magnetic sensor 31B that outputs a sensor signal based on changes in the magnetic field accompanying rotation of the second multipolar magnet 2B.

The first magnetic sensor 31A and the second magnetic sensor 31B each include at least one magnetic detection element and may include a pair of magnetic detection elements connected in series. In this case, the first magnetic sensor 31A has a 1^{st}-1 Wheatstone bridge circuit 311A and a 1^{st}-2 Wheatstone bridge circuit 312A that include the first magnetic detection element and the second magnetic detection element connected in series, and the second magnetic sensor 31B has a 2^{nd}-1 Wheatstone bridge circuit 311B and a 2^{nd}-2 Wheatstone bridge circuit 312B that include the first magnetic detection element and the second magnetic detection element connected in series. The first magnetic sensor 31A and the second magnetic sensor 31B may also have a half bridge circuit that includes only the first magnetic detection element pair and does not include the second magnetic detection element pair, respectively, in place of the 1^{st}-1 Wheatstone bridge circuit 311A, the 1^{st}-2 Wheatstone bridge circuit 312A, the 2^{nd}-1 Wheatstone bridge circuit 311B and the 2^{nd}-2 Wheatstone bridge circuit 312B.

As shown in FIG. 3, the 1^{st}-1 Wheatstone bridge circuit 311A of the first magnetic sensor 31A includes a power source port V11, a ground port G11, two output ports E111 and E112, a first pair of magnetic detection elements R111 and R112 connected in series, and a second pair of magnetic detection elements R113 and R114 connected in series. One end of each of the magnetic detection elements R111 and R113 is connected to the power source port V11. The other end of the magnetic detection element R111 is connected to one end of the magnetic detection element R112 and to the output port E111. The other end of the magnetic detection element R113 is connected to one end of the magnetic detection element R114 and to the output port E112. The other end of each of the magnetic detection elements R112 and R114 is connected to the ground port G11. A power source voltage of a predetermined magnitude is applied on the power source port V11, and the ground port G11 is connected to ground.

As shown in FIG. 4, the 1^{st}-2 Wheatstone bridge circuit 312A of the first magnetic sensor 31A has has the same configuration as the 1^{st}-1 Wheatstone bridge circuit 311A and includes a power source port V12, a ground port G12, two output ports E121 and E122, a first pair of magnetic detection elements R121 and R122 connected in series, and a second pair of magnetic detection elements R123 and R124 connected in series. One end of each of the magnetic detection elements R121 and R123 is connected to the power source port V12. The other end of the magnetic detection element R121 is connected to one end of the magnetic detection element R122 and to the output port E121. The other end of the magnetic detection element R123 is connected to one end of the magnetic detection element R124 and to the output port E122. The other end of each of the magnetic detection elements R122 and R124 is connected to the ground port G12. A power source voltage of a predetermined magnitude is applied on the power source port V12, and the ground port G12 is connected to ground.

As shown in FIG. 5, the 2^{nd}-1 Wheatstone bridge circuit 311B of the second magnetic sensor 31B has has the same configuration as the 1^{st}-1 Wheatstone bridge circuit 311A and includes a power source port V21, a ground port G21, two output ports E211 and E212, a first pair of magnetic detection elements R211 and R212 connected in series, and a second pair of magnetic detection elements R213 and R214 connected in series. One end of each of the magnetic detection elements R211 and R213 is connected to the power source port V21. The other end of the magnetic detection element R211 is connected to one end of the magnetic detection element R212 and to the output port E211. The other end of the magnetic detection element R213 is connected to one end of the magnetic detection element R214 and to the output port E212. The other end of each of the magnetic detection elements R212 and R214 is connected to the ground port G21. A power source voltage of a predetermined magnitude is applied on the power source port V21, and the ground port G21 is connected to ground.

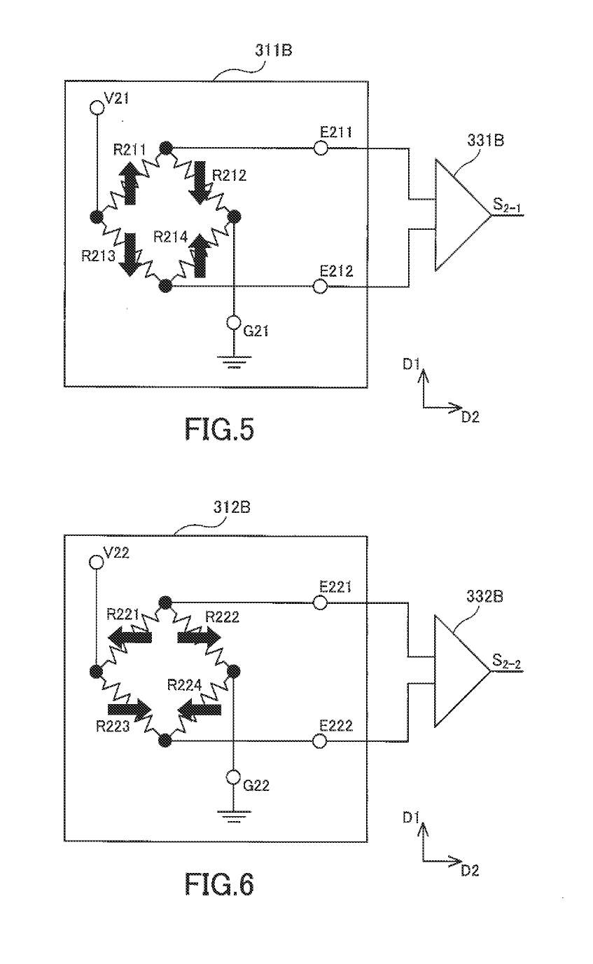

As shown in FIG. 6, the 2^{nd}-2 Wheatstone bridge circuit 312B of the second magnetic sensor 31B has has the same configuration as the 2^{nd}-1 Wheatstone bridge circuit 311B and includes a power source port V22, a ground port G22, two output ports E221 and E222, a first pair of magnetic detection elements R221 and R222 connected in series, and a second pair of magnetic detection elements R223 and R224 connected in series. One end of each of the magnetic detection elements R221 and R223 is connected to the power source port V22. The other end of the magnetic detection element R221 is connected to one end of the magnetic detection element R222 and to the output port E221. The other end of the magnetic detection element R223 is connected to one end of the magnetic detection element R224 and to the output port E222. The other end of each of the magnetic detection elements R222 and R224 is connected to the ground port G22. A power source voltage of a predetermined magnitude is applied on the power source port V22, and the ground port G22 is connected to ground.

In this embodiment, as all of the magnetic detection elements R111˜R124 and R211˜R224 included in the 1^{st}-1 Wheatstone bridge circuit 311A, the 1^{st}-2 Wheatstone bridge circuit 312A, the 2^{nd}-1 Wheatstone bridge circuit 311B and the 2^{nd}-2 Wheatstone bridge circuit 312B, MR elements such as TMR elements, GMR elements, AMR elements or the like, or magnetic detection elements such as Hall elements, can be used, and using TMR elements is particularly preferable. TMR elements and GMR elements have magnetization fixed layers in which the magnetization direction is fixed, free layers in which the magnetization direction changes in accordance with the direction of an applied magnetic field, and nonmagnetic layers positioned between the magnetization fixed layers and the free layers.

Specifically, as shown in FIG. 7, the MR element has a plurality of lower electrodes 41, a plurality of MR films 50 and a plurality of upper electrodes 42. The plurality of lower electrodes 41 is provided on a substrate (not shown in the drawings). Each of the lower electrodes 41 has an elongated shape. A gap is formed between two lower electrodes 41 adjacent in the lengthwise direction of the lower electrodes 41. The MR films 50 are respectively provided near the two ends in the lengthwise direction on the top surface of the lower electrodes 41. As shown in FIG. 8, the MR films 50 have a roughly circular shape in a plan view, and include a free layer 51, a nonmagnetic layer 52, a magnetization fixed layer 53 and an antiferromagnetic layer 54 layered in that order from the lower electrode 41 side. The free layer 51 is electrically connected to the lower electrode 41. The antiferromagnetic layer 54 is configured by antiferromagnetic materials, and by causing exchange coupling with the magnetization fixed layer 53, serves the role of fixing the direction of magnetization of the magnetization fixed layer 53. The plurality of upper electrodes 42 is provided on top of the plurality of MR films 50. Each upper electrode 42 has an elongated shape, is arranged on two of the lower electrodes 41 adjacent in the lengthwise direction of the lower electrodes 41, and electrically connects the antiferromagnetic layers 54 of two adjacent MR films 50. The MR films 50 may be configured to have the free layer 51, the nonmagnetic layer 52, the magnetization fixed layer 53 and the antiferromagnetic layer 54 layered in that order from the upper electrode 42 side. In addition, the antiferromagnetic layer 54 may be omitted, by making the magnetization fixed layer 53 a so-called self-pinned type fixed layer (Synthetic Ferri Pinned layer, or SFP layer) having a layered ferri structure of a ferromagnetic layer/nonmagnetic intermediate layer/ferromagnetic layer, with the two ferromagnetic layers antiferromagnetically coupled.

In the TMR elements, the nonmagnetic layer 52 is a tunnel barrier layer. In the GMR elements, the nonmagnetic layer 52 is a nonmagnetic conductive layer. In the TMR elements and GRM elements, the resistance value changes in accordance with the angle of the direction of magnetization of the free layer 51 with respect to the direction of magnetization of the magnetization fixed layer 53, the resistance value becomes a minimum when this angle is 0° (when the magnetization directions are mutually parallel), and the resistance value becomes a maximum when the angle is 180° (the magnetization directions are mutually antiparallel).

In FIGS. 3-6, when the magnetic detection elements R111˜R124 and R211˜R224 are TMR elements or GMR elements, the magnetization direction of the magnetization fixed layers 53 thereof are indicated by the filled arrows. In the 1^{st}-1 Wheatstone bridge circuit 311A of the first magnetic sensor 31A, the magnetization directions of the magnetization fixed layers 53 of the magnetic detection elements R111˜R114 are parallel to a first direction D1, and the magnetization direction of the magnetization fixed layers 53 of the magnetic detection elements R111 and R114 and the magnetization direction of the magnetization fixed layers 53 of the magnetic detection elements R112 and R113 are mutually antiparallel directions. In addition, in the 1^{st}-2 Wheatstone bridge circuit 312A, the magnetization directions of the magnetization fixed layers 53 of the magnetic detection elements R121˜R124 are parallel to a second direction D2 orthogonal to the first direction D1, and the magnetization directions of the magnetization fixed layers 53 of the magnetic detection elements R121 and R124 and the magnetization direction of the magnetization fixed layers 53 of the magnetic detection elements R122 and R123 are mutually antiparallel directions.

In the 2^{nd}-1 Wheatstone bridge circuit 311B of the second magnetic sensor 31B, the magnetization directions of the magnetization fixed layers 53 of the magnetic detection elements R211˜R214 are parallel to the first direction D1, and the magnetization direction of the magnetization fixed layers 53 of the magnetic detection elements R211 and R214 and the magnetization direction of the magnetization fixed layers 53 of the magnetic detection elements R212 and R213 are mutually antiparallel directions. In addition, in the 2^{nd}-2 Wheatstone bridge circuit 312B, the magnetization directions of the magnetization fixed layers 53 of the magnetic detection elements R221˜R224 are parallel to the second direction D2 orthogonal to the first direction D1, and the magnetization direction of the magnetization fixed layers 53 of the magnetic detection elements R221 and R224 and the magnetization direction of the magnetization fixed layers 53 of the magnetic detection elements R222 and R223 are mutually antiparallel directions.

In the first magnetic sensor 31A and the second magnetic sensor 31B, the electric potential difference between the output ports E111, E112, E121 and E122 and the output ports E211, E212, E221 and E222 changes in accordance with changes in the direction of the magnetic field accompanying rotation of the input shaft 102A and the output shaft 102B, and a 1^{st}-1 sensor signal S₁₋₁, a 1^{st}-2 sensor signal S₁₋₂, a 2^{nd}-1 sensor signal S₂₋₁ and a 2^{nd}-2 sensor signal S₂₋₂ are output as signals expressing the magnetic field intensity.

Difference detectors 331A and 332A output a signal corresponding to the potential difference between the output ports E111 and E112 to a first operation part 32A and a second operation part 32B as the 1^{st}-1 sensor signal S₁₋₁. Difference detectors 331B and 332B output a signal corresponding to the potential difference between the output ports E121 and E122 to the first operation part 32A and the second operation part 32B as the 1^{st}-2 sensor signal S₁₋₂. The difference detector 331B outputs a signal corresponding to the potential difference between the output ports E211 and E212 to the operation processing part 3C as the 2^{nd}-1 sensor signal S₂₋₁. The difference detector 332B outputs a signal corresponding to the potential difference between the output ports E221 and E222 to the operation processing part 3C as the 2^{nd}-2 sensor signal S₂₋₂.

As shown in FIG. 3 and FIG. 4, the magnetization direction of the magnetization fixed layers 53 of the magnetic detection elements R111˜R114 in the 1^{st}-1 Wheatstone bridge circuit 311A and the magnetization direction of the magnetization fixed layers 53 of the magnetic detection elements R121˜R124 in the 1^{st}-2 Wheatstone bridge circuit 312A are mutually orthogonal. In this case, the waveform of the 1^{st}-1 sensor signal S₁₋₁ is a cosine waveform depending on the rotational angle θ₁ of the first multipolar magnet 2A, and the waveform of the 1^{st}-2 sensor signal S₁₋₂ is a sine waveform depending on the rotational angle θ₁ of the first multipolar magnet 2A. That is to say, the 1^{st}-1 sensor signal S₁₋₁ can be called the first cos signal, and the 1^{st}-2 sensor signal S₁₋₂ can be called the first sin signal.

As shown in FIG. 5 and FIG. 6, the magnetization direction of the magnetization fixed layers 53 of the magnetic detection elements R211˜R214 in the 2^{nd}-1 Wheatstone bridge circuit 311B and the magnetization direction of the magnetization fixed layers 53 of the magnetic detection elements R221˜R224 in the 2^{nd}-2 Wheatstone bridge circuit 312B are mutually orthogonal. In this case, the waveform of the 2^{nd}-1 sensor signal S₂₋₁ is a cosine waveform depending on the rotational angle θ₂ of the second multipolar magnet 2B, and the waveform of the 2^{nd}-2 sensor signal S₂₋₂ is a sine waveform depending on the rotational angle θ₂ of the second multipolar magnet 2B. That is to say, the 2^{nd}-1 sensor signal 524 can be called the second cos signal, and the 2^{nd}-2 sensor signal S₂₋₂ can be called the second sin signal.

The operation processor 3C has a phase difference calculator 31C that calculates the relative phase difference C_{PD} of the input shaft 102A and the output shaft 102B based on the equation (1) below, from the first cos signal (Cos θ₁) and the first sin signal (Sin θ₁) output by the first magnetic sensor 31A, and the second cos signal (Cos θ₂) and the second sin signal (Sin θ₂) output by the second magnetic sensor 31B, and a torque calculator 32C that computes the torque generated in the input shaft 102A and the output shaft 102B on the basis of the relative phase difference C_{PD}.

[Formula 2]

C_{PD}=\sqrt{(S_{S1}−S_{S2})²+(S_{C1}−S_{C2})²} (1)

In Equation (1), C_{PD} indicates the relative phase difference, S_{S1} indicates the first sin signal, S_{C1} indicates the first cos signal, S_{S2} indicates the second sin signal and S_{C2} indicates the second cos signal.

Here, the respective phases (rotational angle) P_{IN} and P_{OUT} of the input shaft 102A and the output shaft 102B can be expressed by equations (2) and (3) below.

$$\begin{matrix}[ Formula 3 ] & \\ {P}_{IN} = \sqrt{{( {S}_{S 1} )}^{2} + {( {S}_{C 1} )}^{2}} = \sqrt{{( sin {θ}_{1} )}^{2} + {( cos {θ}_{1} )}^{2}} & ( 2 ) \\ {P}_{OUT} = \sqrt{{( {S}_{S 2} )}^{2} + {( {S}_{C 2} )}^{2}} = \sqrt{{( sin {θ}_{2} )}^{2} + {( cos {θ}_{2} )}^{2}} & ( 3 )\end{matrix}$$

In Equations (2) and (3), P_{IN} indicates the phase of the input shaft 102A, Pour indicates the phase of the output shaft 102B, S_{S1} indicates the first sin signal, S_{C1} indicates the first cos signal, S_{S2} indicates the second sin signal and S_{C2} indicates the second cos signal.

When the relative twist angle Δθ between the input shaft 102A and the output shaft 102B is 0 (zero), the relative phase difference C_{PD} between the input shaft 102A and the output shaft 102B indicated by Equation (1) also becomes 0 (zero). In this case, torque is not generated in the input shaft 102A and the output shaft 102B. On the other hand, when the relative twist angle Δθ between the input shaft 102A and the output shaft 102B is not 0 (zero), the relative phase difference C_{PD} between the input shaft 102A and the output shaft 102B is expressed by Equation (4) below.

$$\begin{matrix}[ Formula 4 ] & \\ \begin{matrix}{C}_{PD} = \sqrt{{( sin {θ}_{1} - sin ( {θ}_{1} + Δθ ) )}^{2} + {( cos {θ}_{1} - cos ( {θ}_{1} + Δθ ) )}^{2}} \\ = \sqrt{\begin{matrix}{( sin {θ}_{1} )}^{2} + {( sin ( {θ}_{1} + Δθ ) )}^{2} - 2 ( sin {θ}_{1} \cdot sin ( {θ}_{1} + Δθ ) ) + {( cos {θ}_{1} )}^{2} + \\ {( cos ( {θ}_{1} + Δθ ) )}^{2} - 2 ( cos {θ}_{1} \cdot cos ( {θ}_{1} + Δθ ) )\end{matrix}} \\ = \sqrt{- 2 ( sin {θ}_{1} \cdot sin ( {θ}_{1} + Δθ ) ) - 2 ( cos {θ}_{1} \cdot cos ( {θ}_{1} + Δθ ) ) + 2} \\ = \sqrt{\begin{matrix}- 2 ( - 1 / 2 ) ( cos ( {θ}_{1} + {θ}_{1} + Δθ ) - cos ( {θ}_{1} - {θ}_{1} - Δθ ) ) - 2 ( 1 / 2 ) \\ ( cos ( {θ}_{1} + {θ}_{1} + Δθ ) - cos ( {θ}_{1} - {θ}_{1} - Δθ ) ) + 2\end{matrix}} \\ = \sqrt{2 ( 1 - cos ( Δθ ) )} \\ = \sqrt{2 ( 2 {sin ( Δθ / 2 )}^{2} )} = 2 sin ( Δθ / 2 )\end{matrix} & ( 4 )\end{matrix}$$

Here, when the relative twist angle Δθ between the input shaft 102A and the output shaft 102B is sufficiently small (for example, when Δθ is 10° or less, and preferably 5° or less), sin θ₁ can be close to θ₁, so the relative phase difference C_{PD} and the relative twist angle Δθ between the input shaft 102A and the output shaft 102B have a predetermined correlation indicated in Equation (4) above.

Consequently, the relative phase difference C_{PD} between the input shaft 102A and the output shaft 102B is calculated by the phase difference calculator 31C from the first cos signal (Cos θ₁) and the first sin signal (Sin θ₁) output from the first magnetic sensor 31A, and the second cos signal (Cos θ₂) and the second sin signal (Sin θ₂) output from the second magnetic sensor 31B, and through this the relative twist angle Δθ can be found based on the correlation (Equation (4)) between the relative phase difference C_{PD} of the input shaft 102A and the output shaft 102B and the relative twist angle Δθ. Furthermore, the torque generated in the input shaft 102A and the output shaft 102B can be calculated by the torque calculator 32C based on the relative twist angle Δθ. The relative twist angle Δθ may also be found by preparing a table or the like indicating the correlation between the relative phase difference C_{PD} and the relative twist angle Δθ in advance and referring to the table or the like.

The torque calculator 32C calculates the torque generated in the input shaft 102A and the output shaft 102B based on the relative twist angle Δθ found from the above-described correlation (Equation (4)). That is to say, if the relative twist angle Δθ between the input shaft 102A and the output shaft 102B connected via the torsion bar 102C is obtained, the torque can be calculated through a commonly known calculation method using the cross-sectional secondary polar moment, the transverse electricity coefficient, the length, the diameter and the like of the torsion bar 102C.

The operation processing part 3C may also include a memory part (not illustrated), in addition to the phase difference calculator 31C and the torque calculator 32C. The memory part stores the torque generated in the input shaft 102A and output shaft 102B calculated by the torque calculator 32C and a table indicating the correlation between the relative phase difference C_{PD} of the input shaft 102A and the output shaft 102B and the relative twist angle Δθ, and the like. The operation processor 3C may be configured from a microcomputer, an Application Specific Integrated Circuit (ASIC) or the like, for example, that is capable of realizing operation processing of the relative phase difference C_{PD}, the relative twist angle Δθ and the torque.

In the torque sensor 1 having the above configuration, when the first multipolar magnet 2A and the second multipolar magnet 2B rotate accompanying rotation of the input shaft 102A and the output shaft 102B, the magnetic fields of the first multipolar magnet 2A and the second multipolar magnet 2B change. The resistance values of the magnetic detection elements R111˜R124 and R211˜R224 of the first magnetic sensor 31A and the second magnetic sensor 31B change in accordance with changes in the magnetic field, and the first cos signal (Cos θ₁) and first sin signal (Sin θ₁) and the second cos signal (Cos θ₂) and second sin signal (Sin θ₂) are output in accordance with the potential difference between the respective output ports E111, E112, E121, E122, E211, E212, E221 and E222. Furthermore, the relative phase difference C_{PD} between the input shaft 102A and the output shaft 102B is calculated by the phase difference calculator 31C, and the torque is calculated by the torque calculator 32C based on the relative twist angle Δθ found from the correlation with the relative phase difference C_{PD}.

In this manner, with the torque sensor 1 according to this embodiment, it is possible to compute the torque without accomplishing arctangent (atan) operation processing by the operation processor 3C, so it is not necessary to enlarge the circuit scale of the operation processing circuit, and it is possible to reduce the power consumption in the torque sensor 1. In addition, it is not necessary to accomplish arctangent (atan) operation processing that requires a large number of clock cycles, so it is possible to compute the torque in an extremely short time.

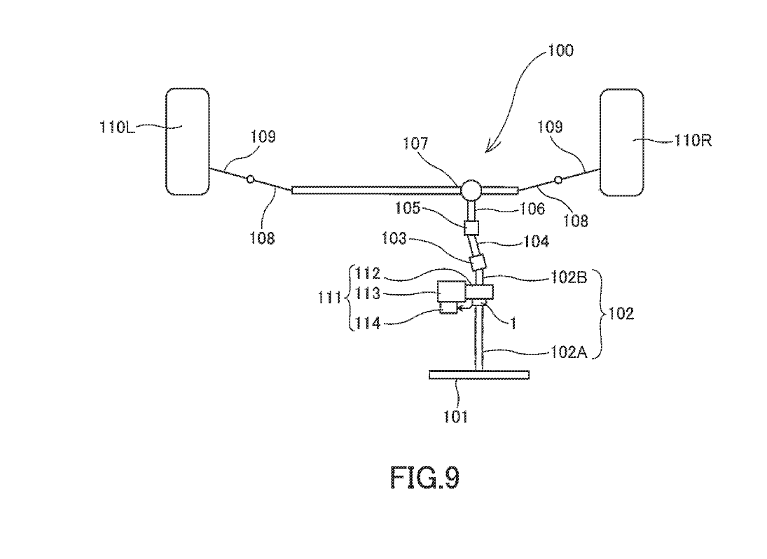

Next, the configuration of an electric power-assisted steering that uses the rotational angle detection apparatus according to this embodiment will be described. FIG. 9 is a schematic configuration diagram of an electric power-assisted steering apparatus that uses the torque sensor according to this embodiment

An electric power-assisted steering apparatus 100 is provided with a steering wheel 101, a steering shaft 102, the torque sensor 1 according to this embodiment, a first universal joint 103, a lower shaft 104, a second universal joint 105, a pinion shaft 106, a steering gear 107, tie rods 108 and knuckle arms 109. The knuckle arms 109 are respectively attached to the front wheels 110R and 110L of the vehicle.

The steering force with which the driver steers the steering wheel 101 is conveyed to the steering shaft 102. The steering shaft 102 includes an input shaft 102A and an output shaft 102B. One end of the input shaft 102A is connected to the steering wheel 101, and the other end is connected to one end of the output shaft 102B via the torque sensor 1. Accordingly, the steering force conveyed to the output shaft 102B of the steering shaft 102 is conveyed to the lower shaft 104 via the first universal joint 103 and is conveyed to the pinion shaft 106 via the second universal joint 105. The steering force conveyed to the pinion shaft 106 is conveyed to the tie rods 108 via the steering gear 107, the steering force conveyed to the tie rods 108 is conveyed to the knuckle arms 109, and the front wheels are steered.

A steering assist mechanism 111 that conveys a steering assist force to the output shaft 102B is connected to the output shaft 102B of the steering shaft 102. The steering assist mechanism 111 is provided with a reduction gear 112 that is connected to the output shaft 102B and configured by a worm gear mechanism or the like, an electric motor 113 that is connected to the reduction gear 112 and generates the steering assist force, and an electric power-assisted steering (EPS) control part 114 that is fixedly supported to the housing of the electric motor 113.

When the steering wheel 101 is steered by the driver of the vehicle and this steering force is conveyed to the steering shaft 102, the input shaft 102A rotates in a direction corresponding to the steering direction. Accompanying this rotation, the end of the torsion bar 102C on the input shaft 102A side rotates, and the first multipolar magnet 2A provided on the input end of the torsion bar 102C rotates. The resistance values of the magnetic detection elements R111˜R124 of the first magnetic sensor 31A change in accordance with the change in the magnetic field accompanying rotation of the first multipolar magnet 2A, and the first cos signal (Cos θ₁) and first sin signal (Sin θ₁) are output to the operation processor 3C in accordance with the respective potential differences between the output ports E111, E112, E121 and E122.

On the other hand, the steering force that causes the input shaft 102A to rotate is conveyed to the end on the output shaft 102B side via twisting (elastic deformation) of the torsion bar 102C, and the output shaft 102B rotates. That is to say, the input shaft 102A and the output shaft 102B are relatively displaced in the rotational direction. Through this, the second multipolar magnet 2B provided on the output end of the torsion bar 102C rotates. The resistance values of the magnetic detection elements R211˜R224 of the second magnetic sensor 31B change in accordance with changes in the magnetic field accompanying rotation of the second multipolar magnet 2B, and the second cos signal (Cos θ₂) and second sin signal (Sin θ₂) are output to the operation processor 3C in accordance with the respective potential differences between the output ports E211, E212, E221 and E222.

The phase difference calculator 31C of the operation processor 3C calculates the relative phase difference C_{PD} by the first cos signal (Cos θ₁), the first sin signal (Sin θ₁), the second cos signal (Cos θ₂) and the second sin signal (Sin θ₂), and computes the relative twist angle Δθ from the predetermined correlation. Then, the torque calculator 32C computes the torque based on the relative twist angle Δθ. The torque calculated by the torque calculator 32C is output to the EPS control part 114, and the EPS control part 114 computes the electric current command value based on the torque value from the torque calculator 32C, the vehicle speed from a vehicle speed sensor and the motor rotation angle from the electric motor. Then, a three-phase alternating current in accordance with this electric current command value is generated and supplied to the electric motor, and a steering assist force is generated in the electric motor.

In the electric power-assisted steering apparatus 100 having the above-described configuration, the torque value necessary for generating the steering assist force is computed by the torque sensor 1 according to this embodiment. In this torque sensor 1, it is possible to compute the torque value without accomplishing arctangent (atan) operation processing by the operation processor 3C, and it is possible to compute the torque value in an extremely short time with small power consumption. Consequently, with the electric power-assisted steering apparatus 100 according to this embodiment, a competent steering assist force can be generated in accordance with steering of the steering wheel 101 by the driver.

The above-described embodiment is disclosed in order to facilitate understanding of the present invention and is not disclosed to limit the present invention. Accordingly, the various elements disclosed in the above-described embodiment include all design modifications and equivalents that fall within the technical scope of the present invention.

### DESCRIPTION OF REFERENCE SYMBOLS

1 Torque sensor
2A First multipolar magnet (first magnetic field generator)
2B Second multipolar magnet (second magnetic field generator)
3 Magnetic detection apparatus
3A First magnetic detection apparatus
31A First magnetic sensor
3B Second magnetic detection apparatus
31B Second magnetic sensor
3C Operation processor (operation processing apparatus)
31C Phase difference calculator
32C Torque calculator
100 Electric power-assisted steering apparatus
102A Input shaft (first rotation shaft)
102B Output shaft (second rotation shaft)
102C Torsion bar
113 Electric motor (power generator)
114 EPS control part (controller)

1. An operation processing apparatus that computes torque generated in a first rotation shaft and a second rotation shaft connected via a torsion bar and arranged coaxially by using a first output signal including a first sine wave signal and a first cosine wave signal output from a first magnetic sensor element in accordance with rotation of the first rotation shaft, and a second output signal including a second sine wave signal and a second cosine wave signal output from a second magnetic sensor element in accordance with rotation of the second rotation shaft,
the operation processing apparatus comprising:
a phase difference calculation part that computes the relative phase difference between the first rotation shaft and the second rotation shaft from the first output signal and the second output signal based on Equation (1) below; and
a torque calculation part that computes the torque from a relative twist angle that is expressed as a difference in rotational angles between the first rotation shaft and the second rotation shaft and that is found based on a correlation between the relative phase differences computed by the phase difference calculation part.
[Equation 1]
C_{PD}=\sqrt{(S_{S1}−S_{S2})²+(S_{C1}−S_{C2})²} (1)
In Equation (1), C_{PD} indicates the relative phase difference, S_{S1} indicates the first sine wave signal, S_{C1} indicates the first cosine wave signal, S_{S2} indicates the second sine wave signal and S_{C2} indicates the second cosine wave signal.

2. The operation processing apparatus according to claim 1, further comprising a memory part that stores the correlation between the relative twist angles and the relative phase differences in advance;
wherein the torque calculation part computes the torque from the relative twist angle found based on the correlation stored in the memory part and the relative phase difference computed by the phase difference calculation part.

3. The operation processing apparatus according to claim 1, wherein the relative twist angle is 10° or less.

4. A torque sensor comprising:
the operation processing apparatus according to claim 1;
a first magnetic field generation part that is provided on the first rotation shaft and that rotates integrally with the first rotation shaft;
a second magnetic field generation part that is provided on the second rotation shaft and that rotates integrally with the second rotation shaft; and
a magnetic sensor part that includes the first magnetic sensor element and the second magnetic sensor element;
wherein the first magnetic field generation part and the second magnetic field generation part are multipolar magnets such that the different magnetic poles are arranged alternately in a radial direction;
the first magnetic sensor element outputs the first output signal in accordance with the magnetic field generated from the first magnetic field generation part; and
the second magnetic sensor element outputs the second output signal in accordance with the magnetic field generated from the second magnetic field generation part.

5. The torque sensor according to claim 4, wherein each of the first magnetic sensor element and the second magnetic sensor element is a TMR element, a GMR element, an AMR element or a Hall element.

6. A steering apparatus comprising:
a power generation part that gives power to a steering mechanism for steering and that assists the steering power of the steering;
the torque sensor according to claim 4; and
a control part that drives the power generation part in accordance with the torque detected by the torque sensor.
